(19) United States
(12) Patent Application Publication
(10) Pub. No.: US 2026/0326826 A1
(43) Pub. Date: Oct. 22, 2026

(54) FRONT STRUCTURE OF A MOTOR VEHICLE

(71) Applicant: FLEXIS, BOULOGNE-BILLANCOURT (FR)

(72) Inventor: Roberto GUERCIO, GUYANCOURT (FR)

(21) Appl. No.: 19/648,434

(22) Filed: Apr. 15, 2026

(30) Foreign Application Priority Data
Apr. 16, 2025 (FR) FR2504084

(51) Int. Cl. B62D 25/08; B60J 1/02; B60Q 1/26; B60Q 1/28; B60R 13/04; B60R 13/07; B60S 1/04; B62D 25/04; B62D 25/10; B62D 25/12; B62D 25/16

(52) U.S. Cl. CPC B62D 25/081; B60J 1/02; B60Q 1/2619; B60Q 1/28; B60R 13/04; B60R 13/07; B60S 1/043; B60S 1/0452; B62D 25/04; B62D 25/105; B62D 25/12; B62D 25/16

(57) ABSTRACT

A front structure of a motor vehicle includes a windshield, a cowl panel, extending along a lower edge of the windshield, and a lateral arrangement, including: a pillar, fixed to an end of the windshield; a fender, extending rearward from the pillar; and a daytime running light including a front face. The lateral arrangement further includes a trim part, including: a rear edge; a front portion extending from a first portion of the rear edge to the front face of the daytime running light; a lateral portion having a curved shape and forming a continuous surface with the fender; and a protective portion inclined in relation to the lateral portion.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The present disclosure relates to a front structure of a motor vehicle, of the type that includes a windshield, intended to form a front surface of the vehicle in a direction of travel of said vehicle, the windshield extending in a transverse direction of the vehicle between a first and second end, the windshield extending substantially vertically between a lower edge and an upper edge; a cowl panel extending in the transverse direction along the lower edge of the windshield between first and second ends; and a first lateral arrangement; the first lateral arrangement including a pillar, fixed to the first end of the windshield and extending substantially vertically between a lower end and an upper end; a fender, extending substantially rearward in the direction of travel from the lower end of the pillar; and a daytime running light, substantially aligned in the direction of travel with the first end of the cowl panel, said daytime running light being positioned in front of said cowl panel; the daytime running light comprising a front face, said front face comprising an upper edge extending substantially horizontally.

### BACKGROUND

In most known vehicles, a hood extends between the windshield and the front lights of the vehicle, and a lateral space is provided between the cowl panel and each fender of the vehicle. Such a lateral space is generally concealed by an additional part, positioned between the hood and the corresponding fender. Such a part is generally small in size and difficult to connect firmly to the vehicle structure. Such a part can therefore be easily damaged or stolen, which exposes part of the internal equipment of the vehicle.

### SUMMARY

The aim of the present disclosure is to propose an improved front structure, adapted in particular to a very short distance between the windshield and the front lights of the vehicle, in particular the daytime running lights.

To this end, the present disclosure relates to a front structure of the aforementioned type, wherein the first lateral arrangement further includes a trim part, said trim part comprising a rear edge comprising first and second portions as an extension of one another, the second portion having a curved shape; a substantially planar front portion, extending in the direction of travel from the first portion of the rear edge to the upper edge of the front face of the daytime running light; a lateral portion, formed as a single piece with the front portion, said lateral portion having a curved shape, extending from the second portion of the rear edge and forming a continuous surface with the fender; and a protective portion, formed as a single piece with the lateral portion and inclined in relation to said lateral portion, said protective portion extending substantially downward from the second portion of the rear edge to a free edge positioned facing the windshield.

According to other advantageous aspects of the present disclosure, the front structure includes one or more of the following features, taken alone or in any technically possible combination:
The protective portion forms a curved surface, having a concavity oriented toward the upper edge of the windshield;
a first distance between the windshield and the free edge of the protective portion is less than a second distance between the windshield and the first portion of the rear edge of the trim part;
the front structure comprises a front cavity, provided between the windshield and the cowl panel on the one hand and the trim part of the first lateral arrangement on the other hand; and the first portion of the rear edge of the trim part is a free edge bordering said front cavity;
the daytime running light of the first lateral arrangement includes a housing, fixed to the front face and positioned behind said front face, said housing being positioned under the front portion of the trim part and in the front cavity;
the cowl panel comprises a first hinge opening, positioned near the first end of said cowl panel; the first hinge opening is positioned in the front cavity; and the front structure further comprises a windshield wiper, assembled to the first hinge opening;
the front structure further comprises a central trim part, extending the trim part of the first lateral arrangement in the transverse direction, the front cavity also extending between the windshield and the cowl panel on the one hand and the central trim part on the other hand;
the cowl panel comprises a gutter, positioned in the front cavity, open upward and extending in the transverse direction;
the front structure further comprises a second lateral arrangement, substantially symmetrical to the first lateral arrangement in relation to a median plane of the front structure.

The present disclosure also relates to a motor vehicle comprising a front structure as described above.

### BRIEF DESCRIPTION OF THE DRAWINGS

The present disclosure will appear more clearly from reading the description that follows, given solely by way of non-limiting example and made with reference to the drawings wherein:

FIG. 1 is a perspective view of a front structure according to one embodiment of the present disclosure;

FIG. 2 is a partial view of the front structure of FIG. 1; and

FIG. 3 is a sectional view of the front structure of FIGS. 1 and 2.

### DETAILED DESCRIPTION

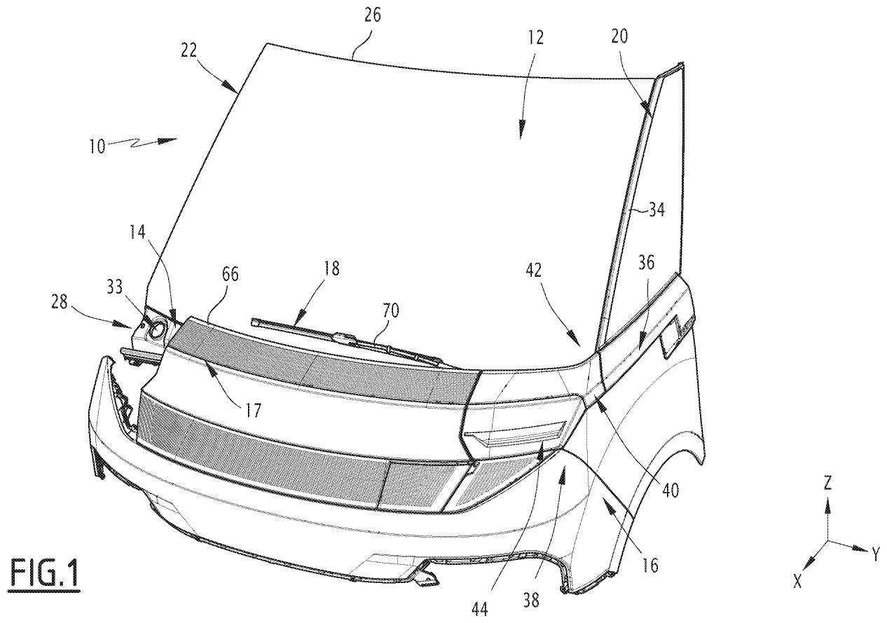

FIGS. 1 to 3 show a front structure 10 according to one embodiment of the present disclosure. The front structure 10 is intended to be integrated in particular into a motor vehicle (not shown).

The front structure 10 comprises, in particular, a windshield 12, a cowl panel 14 and a first lateral arrangement 16. In the illustrated embodiment, the front structure 10 further comprises a central trim part 17 and at least a first windshield wiper 18.

The windshield 12 is intended to form a front surface of the vehicle in a horizontal direction of travel of said vehicle. In the remainder of the description, the terms “front” and “rear” are understood in relation to said direction of travel.

In the remainder of the description, an X, Y, Z orthonormal frame is considered, with direction X representing the direction of travel of the vehicle and direction Z representing the vertical.

The windshield 12 extends in the direction Y, called the transverse direction, between a first end 20 and a second end 22. Said first end 20 and second end 22 are substantially symmetrical in relation to a median plane (X, Z) of the front structure 10.

In direction Z, the windshield 12 extends between a lower edge 24 and an upper edge 26. Preferably, the windshield 12 is inclined by a non-zero angle in relation to the vertical.

The cowl panel 14 extends in the direction Y along the lower edge 24 of the windshield 12. Said cowl panel 14 extends the windshield 12 downward, substantially forming a continuous surface with said windshield 12.

The cowl panel 14 extends between a first end 27 and a second end 28 in the direction Y. The first end 27 and second end 28 of the cowl panel 14 are positioned below the respectively first end 20 and the second end 22 of the windshield 12.

Opposite the lower edge 24 of the windshield 12, the cowl panel 14 includes a gutter 30, open upward and extending in the direction Y.

Moreover, the cowl panel 14 includes at least a first hinge opening 32, positioned near the first end 27 of said panel. The first hinge opening 32 is located between the windshield 12 and the gutter 30. Preferably, the cowl panel 14 includes a similar second hinge opening 33, positioned near the second end 28.

The first lateral arrangement 16 will be described later. Preferably, the front structure 10 further comprises a second lateral arrangement, not shown. In the remainder of the description, said second lateral arrangement is considered symmetrical to the first lateral arrangement 16, in relation to the median plane (X, Z) of the front structure 10.

The first lateral arrangement 16 includes a pillar 34, a fender 36, a daytime running light 38 and a trim part 40.

The pillar 34 is fixed to the first end 20 of the windshield 12 and extends substantially vertically between a lower end 42 and an upper end.

The fender 36 extends substantially rearward in the direction X from the lower end 42 of the pillar 34. Preferably, the fender 36 forms an external lateral surface of the vehicle.

The daytime running light 38 is substantially aligned in the direction X with the first end 27 of the cowl panel 14, said daytime running light being positioned in front in relation to said cowl panel.

The daytime running light 38 comprises a front face 44, said front face comprising an upper edge 46. Said upper edge extends substantially horizontally. Preferably, the upper edge 46 of the front face 44 extends substantially in the transverse direction Y.

In the illustrated embodiment, the daytime running light 38 further comprises a housing 48 assembled to the front face 44 and located behind said front face.

It should be noted, in the illustrated embodiment, that the daytime running light 38 is much closer in the direction X to the windshield 12 and the cowl panel 14 than are the signal lights of most known motor vehicles.

The trim part 40 comprises a rear edge 50, a front portion 52, a lateral portion 54 and a protective portion 56.

The rear edge 50 of the trim part 40 comprises a first portion 60 and a second portion 62, as an extension of each another. The first portion 60 of the rear edge extends substantially in the transverse direction Y and is preferably substantially straight. The second portion 62 has a shape curved rearward in the direction of travel X. The first portion 60 of the rear edge 50 is closer to the median plane (X, Z) of the vehicle than the second portion 62.

The front portion 52 of the trim part 40 is substantially planar and extends in the direction X between the first portion 60 of the rear edge 50 and the upper edge 46 of the front face 44 of the daytime running light 38.

The lateral portion 54 of the trim part 40 is formed as a single piece with the front portion. The lateral portion 54 has a curved shape, extending from the second portion 62 of the rear edge 50 and forming a continuous surface with the fender 36.

The protective portion 56 is formed as a single piece with the lateral portion 54 and inclined in relation to said lateral portion. More precisely, the protective portion 56 extends substantially downward from the second portion 62 of the rear edge. Opposite said second portion 62 of the rear edge, the protective portion 56 includes a free edge 64, positioned facing the windshield 12.

Preferably, the protective portion 56 forms a curved surface that has a concavity oriented toward the upper edge 26 of the windshield 12.

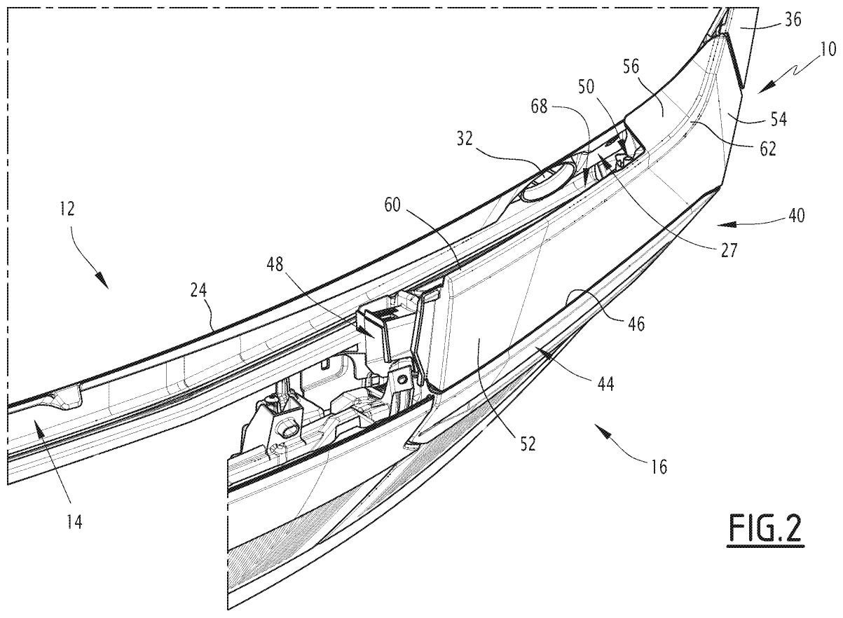

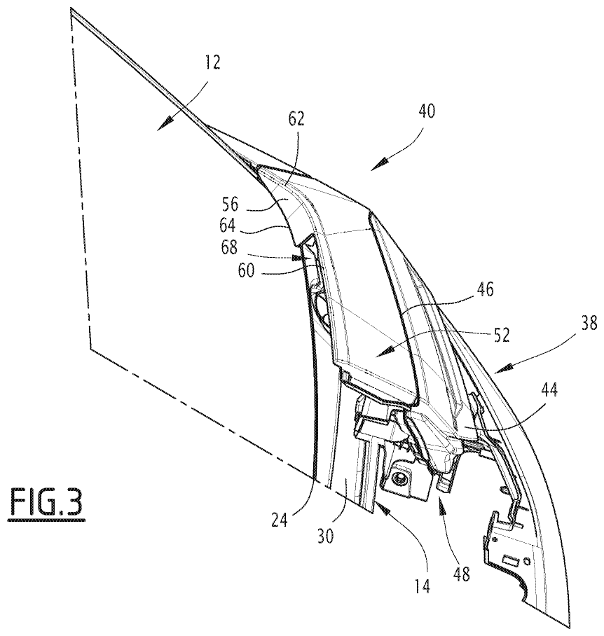

In the illustrated embodiment, the central trim part 17 extends the front portion 52 of the trim part 40 in the direction Y toward the median plane (X, Z). In the illustrated embodiment, said median plane forms a plane of symmetry of the central trim part 17. The central trim part 17 is not visible in FIGS. 2 and 3.

The central trim part 17 includes an upper edge 66 that extends the first portion 60 of the rear edge 50 of the trim part 40 in the direction Y.

In the illustrated embodiment, the front structure 10 further comprises a front cavity 68 open upward. In the direction X, a rear end of the front cavity 68 is formed by the windshield 12 and the cowl panel 14; and a front end of said front cavity 68 is formed by the central trim part 17 and the trim part 40 of the first 16 and second lateral arrangements.

In the illustrated embodiment, the first portion 60 of the rear edge 50 of the trim part 40 is a free edge bordering the front cavity 68. More precisely, the front cavity 68 is open at the first portion 60 of the rear edge 50 of the trim part 40. Conversely, the protective portion 56 of the trim part 40 at least partially closes the front cavity 68 at the second portion 62 of the rear edge 50 of the trim part 40.

In other words, a first distance between the windshield 12 and the free edge 64 of the protective portion 56 is less than a second distance between the windshield 12 and the first portion 60 of the rear edge 50 of the trim part 40.

As such, the protective portion 56 of the trim part 40 at least partially conceals elements positioned in the front cavity 68 from the outside of the vehicle.

For example, the housing 48 of the daytime running light 38 is positioned under the trim part 40 in the front cavity 68. In particular, the housing 48 of the daytime running light 38 is positioned under the front portion 52 of the trim part 40. The protective portion 56 of the trim part 40 partially conceals said housing 48 from the outside of the vehicle.

Moreover, in the illustrated embodiment, the upper edge 66 of the central trim part 17 is a free edge bordering the front cavity 68. More precisely, the front cavity 68 is open at the upper edge 66 of the central trim part 17.

Preferably, as in the illustrated embodiment, the lower edge 24 of the windshield 12 and the cowl panel 14 are positioned in the front cavity 68. In other words, the first portion 60 of the rear edge 50 of the trim part 40 and the upper edge 66 of the central trim part 17 are located higher in direction Z than the lower edge 24 of the windshield 12 and the cowl panel 14.

In particular, the first end 27 of the cowl panel 14 is positioned in the front cavity 68. According to one embodiment, a space (not shown) is provided in the direction Y between said first end 27 of the cowl panel 14 and the fender 36 of the first lateral arrangement 16. Said space is at least partially concealed by the protective portion 56 of the trim part 40 from the outside of the vehicle.

As a result, the gutter 30 of the cowl panel 14 is positioned in the front cavity 68. In particular, the gutter 30 is able to collect rainwater falling into the front cavity 68 and/or running down the windshield 12.

Likewise, the first hinge opening 32 is positioned in the front cavity 68 of the front structure 10.

In the illustrated embodiment, the first windshield wiper 18 comprises an arm 70 and a joint (not shown) positioned at one end of said arm 70. The joint of the first windshield wiper 18 is assembled to the first hinge opening 32 of the cowl panel 14. The arm 70 of the first windshield wiper 18 is rotationally movable in relation to the cowl panel 14. In particular, the arm 70 is able to emerge from the front cavity 68 so as to sweep the windshield 12. The joint of the first windshield wiper 18 is partially concealed from the outside of the vehicle.

Preferably, the second hinge opening 33 is positioned in the front cavity 68; and the front structure 10 further comprises a second windshield wiper (not shown) assembled to the second hinge opening 33.

The front structure 10 described above is suited to a very short distance between the windshield 12 and the daytime running lights 38. The trim part 40 of each lateral arrangement can be securely attached to the rest of the front structure 10, in particular to the corresponding daytime running light 38. Such a configuration improves the robustness and durability of the front structure 10 over time.

What is claimed is:

1. A front structure of a motor vehicle, comprising:
a windshield configured to form a front surface of the motor vehicle in a direction of travel of said motor vehicle, the windshield extending in a transverse direction that is transverse to the direction of travel of the motor vehicle between a first end and a second end, the windshield extending substantially vertically between a lower edge and an upper edge;
a cowl panel extending in the transverse direction along the lower edge of the windshield between a first end and a second end; and
a first lateral arrangement comprising:
a pillar fixed to the first end of the windshield and extending substantially vertically between a lower end and an upper end;
a fender extending substantially rearward in the direction of travel from the lower end of the pillar;
a daytime running light substantially aligned in the direction of travel with the first end of the cowl panel, said daytime running light being positioned in front in relation to said cowl panel, the daytime running light comprising a front face, said front face comprising an upper edge extending substantially horizontally; and
a trim part comprising:
a rear edge comprising a first portion and a second portion as an extension of one another, the second portion having a curved shape;
a front portion that is substantially planar, the front portion extending in the direction of travel from the first portion of the rear edge to the upper edge of the front face of the daytime running light;
a lateral portion formed as a single piece with the front portion, said lateral portion having a curved shape, the lateral portion extending from the second portion of the rear edge and forming a continuous surface with the fender; and
a protective portion formed as a single piece with the lateral portion and inclined in relation to said lateral portion, said protective portion extending substantially downward from the second portion of the rear edge to a free edge positioned facing the windshield.

2. The front structure according to claim 1, wherein the protective portion forms a curved surface having a concavity oriented toward the upper edge of the windshield.

3. The front structure according to claim 1, wherein a first distance between the windshield and the free edge of the protective portion is less than a second distance between the windshield and the first portion of the rear edge of the trim part.

4. The front structure according to claim 1, comprising a front cavity provided between the windshield and the cowl panel and between the windshield and the trim part of the first lateral arrangement, and the first portion of the rear edge of the trim part is a free edge bordering said front cavity.

5. The front structure according to claim 4, wherein the daytime running light of the first lateral arrangement comprises a housing fixed to the front face and positioned behind said front face, said housing being positioned under the front portion of the trim part and in the front cavity.

6. The front structure according to claim 4, wherein the cowl panel comprises a first hinge opening positioned near the first end of said cowl panel, the first hinge opening is positioned in the front cavity, and the front structure further comprises a windshield wiper assembled to the first hinge opening.

7. The front structure according to claim 4, further comprising a central trim part extending the trim part of the first lateral arrangement in the transverse direction, the front cavity extending between the windshield and the cowl panel and between the windshield and the central trim part.

8. The front structure according to claim 4, wherein the cowl panel comprises a gutter positioned in the front cavity, open upward and extending in the transverse direction.

9. The front structure according to claim 1, further comprising a second lateral arrangement substantially symmetrical to the first lateral arrangement in relation to a median plane of the front structure.

10. A motor vehicle comprising the front structure according to claim 1.
